(19) United States
(12) Patent Application Publication
(10) Pub. No.: US 2025/0136220 A1
(43) Pub. Date: May 1, 2025

(54) Container for a Single-Track Motor Vehicle

(71) Applicant: Bayerische Motoren Werke Aktiengesellschaft, Muenchen (DE)

(72) Inventors: Cliff VIZER, Moenchweiler (DE); Ian ROWLEY, Niedereschach (DE)

(21) Appl. No.: 18/690,591

(22) PCT Filed: Sep. 23, 2022
(86) PCT No.: PCT/EP2022/076486

§ 371 Date: Mar. 8, 2024

(30) Foreign Application Priority Data
Oct. 14, 2021 (DE) 10 2021 126 618.1

(51) Int. Cl. B62J 9/23

(52) U.S. Cl. CPC B62J 9/23

(57) ABSTRACT

A container, in particular a top case or a side case, for a single-track motor vehicle, includes a first container element and a second container element. The first container element and the second container element are hard shell elements in particular, wherein the first container element can be secured to the single-track motor vehicle, and the second container element has an opening/cover for a piece of luggage. The first container element and the second container element are arranged so as to overlap one over the other such that the second container element can be moved on the first container element between a first retracted position and a second extended position, and the volume of the container can be modified. A spindle system is arranged on the inner face of the first container system and the inner face of the second container element, and the second container element can be continuously adjusted and fixed between the first retracted position and the second extended position by the spindle system.

### BACKGROUND AND SUMMARY

The invention relates to a container, in particular a top case or a side case, for a single-track motor vehicle, having a first container element and a second container element.

The prior art for width-adjustable hardshell motorcycle cases is a top case or side case which is based on a gear mechanism. This system is a dual-stage system, and a differentiation is made between a retracted state and a deployed state. The case can be transferred from the retracted state to the deployed state by activating a bracket.

Moreover, there are width-adjustable systems for motorcycle luggage, which consist of, for example, a flexible material such as textiles or leather, and therefore dispense with a gear mechanism.

Disclosed in EP 1 566 328 is a case that has a first case part and a second case part which is connected to the first case part and is arranged so as to be laterally displaceable in relation to the first case part, wherein the width and thus the storage capacity of the side case can be adjusted by displacing the second case part in relation to the first case part.

Publication U.S. Pat. No. 6,505,765 discloses an expandable pannier for a motorcycle, which is adjustable between a contracted state and an expanded state. The expandable pannier comprises a lateral fold and a lateral fold closure mechanism which can be moved from a closed position to an open position so as to set the bag between the contracted state and the expanded state.

Furthermore, publication FR 2 973 329 discloses a case which has an unfolding and locking system for unfolding and locking different elements, e.g. a plurality of shells, of the case, in which the unfolding of the elements in a fan-shaped manner takes place by rotating the elements relative to one another by a deflection plate, and the shells have the shape of orange segments.

In the solutions described above it is disadvantageous that an aerodynamic design is impossible because a gear mechanism has to be installed in a straight line. Moreover, only two states are possible, i.e. a retracted state or a deployed state.

It is, therefore, an object of the present invention to provide a container for a single-track motor vehicle, which has a volume that is continuously adjustable between two positions and at the same time permits an aerodynamic design.

This object is achieved by the combination of features according to the independent claims.

According to the invention, a container, in particular a top case or a side case, for a single-track motor vehicle, has a first container element and a second container element. The first container element and the second container element are in particular a hardshell element. Furthermore, the first container element is fastenable to the single-track motor vehicle, and the second container element has an opening/cover for an item of luggage. Moreover, the first container element and the second container element are arranged to overlap one another in such a manner that the second container element is displaceable between a first retracted position and a second deployed position on the first container element and a volume of the container is variable. Furthermore, a spindle system is arranged on an inside of the first container element and on an inside of the second container element. The second container element herein is able to be continuously displaced and/or fixed between the first retracted position and the second deployed position by means of the spindle system.

Provided in this way is a preferably hardshell two-part motorcycle container which has a potential aerodynamic design and enables a continuous adjustment of the width.

In an advantageous variant of embodiment, the spindle system has at least one continuous timing belt, at least one spindle, at least one spindle nut, at least one timing belt gear, and an activation element for the timing belt. The spindle system is implemented by these components.

In a preferred embodiment of the invention, one end of the at least one spindle is rotationally fixed to the second container element, and the other end of the spindle is self-supporting. The at least one spindle is mounted in the at least one spindle nut. The at least one spindle nut is rotatably mounted on the first container element and connected to the at least one timing belt gear. The at least one spindle nut is preferably integrated in the at least one timing belt gear.

Accordingly, the one end of the spindle herein is fastened to the adjustable container element, whereby the spindle is rotationally fixed, which adjustable container element in turn is fastened to the top of the container. The other end of the spindle is self-supporting. An inverse construction is also contemplated. The spindle leads through the spindle nut. In the retracted state, one end of the spindle is at the smallest possible distance from the spindle nut, whereas the other end of the spindle is at the maximum distance. The spindle nut is located in the interior of a timing belt gear and is fixed therein. A rotation of the timing belt gear leads to the spindle being pushed out of the nut, and one end of the spindle approaching the timing belt gear. The rotary movement is converted into a displacement movement, or into a displacement force, respectively. The spindle presses against the adjustable container element, this enabling the two container elements to be displaced relative to one another. The container is consequently enlarged. A rotation of the timing belt gear in the opposite direction leads to the spindle being pulled back into the nut again, and the volume of the container being decreased.

In an alternative embodiment of the present container, it is provided that the at least one spindle nut is rotationally fixed to the second container element, wherein the at least one spindle is mounted in the at least one spindle nut. Furthermore, one end of the at least one spindle is connected to the at least one timing belt gear, and the other end of the spindle is self- supporting. The spindle is rotatably mounted on the first container element. The at least one timing belt gear is preferably integrated in the at least one spindle. It is advantageous herein that the spindle nut is fastened to the adjustable container element, and the spindle is fastened in the interior of the timing belt gear. A rotation of the timing belt gear in this instance leads to the spindle pulling itself into, or rotating itself out of, the nut.

In an exemplary embodiment of the invention, it is provided that the spindle system has a multiplicity of spindles having in each case one spindle nut and one timing belt gear. It is favorable herein that a linear displacement of the container elements relative to one another is made possible owing to the multiplicity of spindles which are synchronously driven by a timing belt.

The container is preferably designed in such a manner that provided is a continuous timing belt which extends so as to encircle the inside of the first container element. In this way, the timing belt runs along the inside of the first container and contacts all of the timing belt gears, as a result of which the linear displacement of the container elements relative to one another is made possible.

In a further advantageous variant, it is provided according to the invention that the spindle system comprises at least three continuous timing belts which are arranged in a substantially U-shaped manner. At a respective transition from one timing belt to another timing belt, the corresponding timing belts herein extend in each case about one timing belt gear. A separator disc is preferably arranged between the respective timing belts on the timing belt gear. Implemented as a result is a container variant in which there is insufficient space for one continuous timing belt that encircles the contour of the interior of the container.

In one variant of embodiment, the container according to the invention is designed so that the activation element is a rotating knob having a timing belt gear, a timing belt gear driven by a motor, or a lever for displacing the at least one continuous timing belt. These components are particularly suitable for an activation element of a timing belt.

It is furthermore advantageous for the activation element to comprise a telescopic bar which connects the rotating knob and the timing belt gear. The telescopic bar herein is mounted in the timing belt gear so as to be displaceable along a rotation axis of the timing belt gear. As a result, the rotating knob can be extracted for improved handling.

In a preferred embodiment, the container according to the invention is designed so that the spindle system is covered by means of a cover. It is advantageous here that the spindle system in the interior of the container is not visible, this resulting in the container being more visually appealing to the rider.

The features disclosed above can be combined with one another in an arbitrary manner to the extent that this is technically feasible and not contradictory.

Other advantageous refinements of the invention are characterized in the dependent claims, or will be illustrated in more detail hereunder in conjunction with the description of the preferred embodiment of the invention by means of the figures.

### BRIEF DESCRIPTION OF THE DRAWINGS

FIGS. 1a, b are perspective views of a container for a single-track motor vehicle;

FIG. 2 is a sectional view of a container for a single-track motor vehicle;

FIG. 3 is a perspective view of another container for a single-track motor vehicle; and

FIG. 4 is a sectional view of another container for a single-track motor vehicle.

### DETAILED DESCRIPTION OF THE DRAWINGS

The figures are schematic and exemplary. The same reference signs in the figures denote functionally and/or structurally equivalent features.

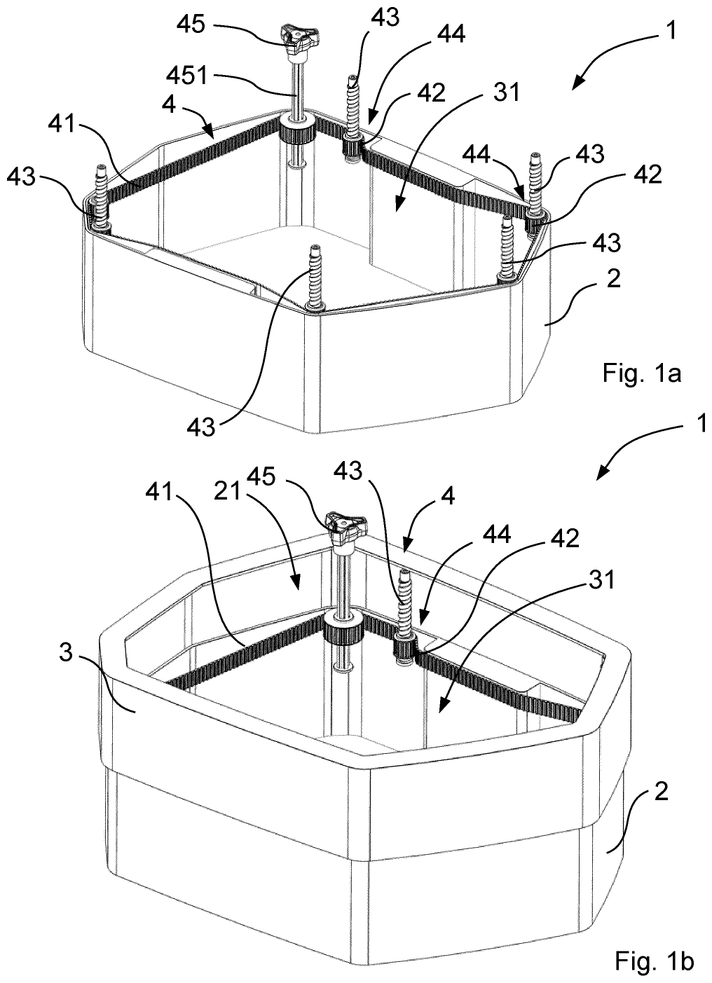

Illustrated in both FIGS. 1a and 1b is a perspective view of a container 1 for a single-track motor vehicle. The container 1 is embodied as a side case for a single-track motor vehicle, having a first container element 2 and a second container element 3. Furthermore, the first container element 2 and the second container element 3 are hardshell elements. The first container element 2 herein is fastenable to the single-track motor vehicle, and the second container element 3 has an opening, not illustrated, for an item of luggage.

Furthermore, the first container element 2 and the second container element 3 are arranged to overlap one another in such a manner that the second container element 3 is displaceable between a first retracted position and a second deployed position on the first container element 2 such that a volume of the container 1 is variable. The second container element 3 in Figure b is in the second deployed position.

A spindle system 4 is arranged on an inside 31 of the first container element 2 and on an inside 21 of the second container element 3. The spindle system 4 comprises a continuous timing belt 41 which extends so as to encircle the inside 21 of the first container element 2. Moreover, the spindle system 4 has five spindles 43, five spindle nuts 44, five timing belt gears 42, and an activation element 45 for the timing belt 41.

The second container element 3 is able to be continuously displaced and fixed between the first retracted position and the second deployed position by means of the spindle system 4.

For this purpose, one end of the respective spindle 43 is rotationally fixed to the second container element 3, and the other end of the respective spindle 43 is self-supporting. Furthermore, the respective one spindle 43 is mounted in the respective spindle nut 44. Moreover, the respective spindle nut 44 is rotatably mounted on the first container element 2 and integrated in the respective timing belt gear 42.

Moreover, the activation element 45 is a rotating knob that has a timing belt gear and comprises a telescopic bar 451 which connects the rotating knob and the timing belt gear. The telescopic bar 451 is mounted in the timing belt gear so as to be displaceable along a rotation axis of the timing belt gear.

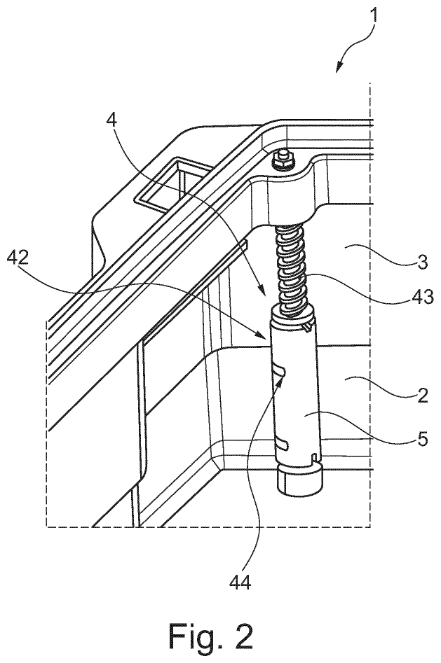

FIG. 2 shows a sectional view of the container 1, illustrated in FIG. 1, for a single-track motor vehicle. Illustrated herein are a spindle 43, a timing belt gear 42 and integrated therein a spindle nut 44 of the spindle system 4, which is arranged on the inside 21, 31 of the first and the second container element 2, 3. Furthermore, the spindle system 4 is covered by means of a cover 5.

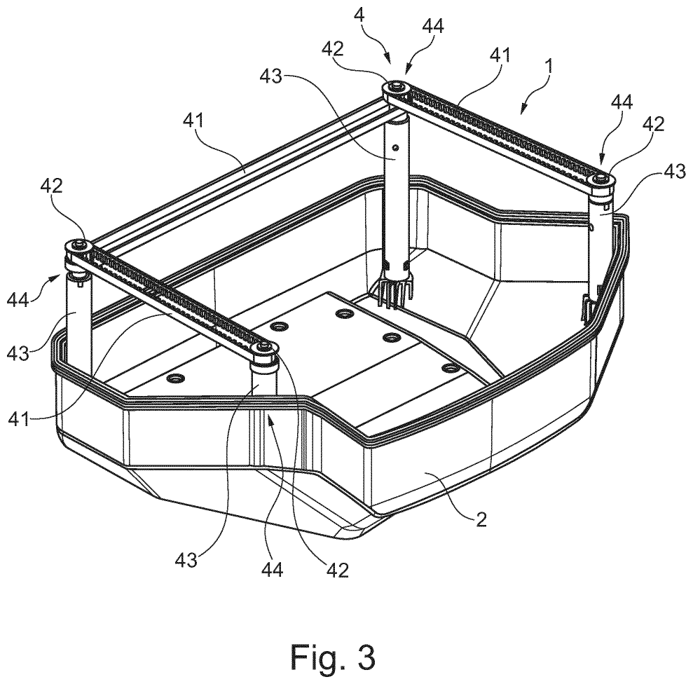

Shown in FIG. 3 is a perspective view of another container 1 for a single-track motor vehicle. Since this container 1 has substantially the same features as the container 1 illustrated in FIG. 1, only different features will be discussed hereunder.

The container 1 is a top case for a single-track motor vehicle. The spindle system 4 comprises three continuous timing belts 41 which are arranged in a substantially U-shaped manner. At a respective transition from one timing belt 41 to another timing belt 41, both timing belts 41 extend in each case about one timing belt gear 42. A separator disc is furthermore arranged between the two timing belts 41 on the timing belt gear 42.

Moreover, four spindles 43, four spindle nuts 44, four timing belt gears 42, and an activation element 45 (not illustrated) for one of the timing belts 41, are arranged on the first container element 2. Furthermore, the respective spindle nut 44, which is not shown in FIG. 3, is rotationally fixed to the second container element 3. The respective spindle 43 is mounted in the respective one spindle nut 44. The respective timing belt gear 42 herein is integrated in one end of the respective spindle 43. The other end of the spindle 43 is self-supporting. Furthermore, the respective spindle 44 is rotatably mounted on the first container element 2.

The activation element 45 is a rotating knob which has a timing belt gear 42, and the spindle system 4 is covered by means of a cover 5.

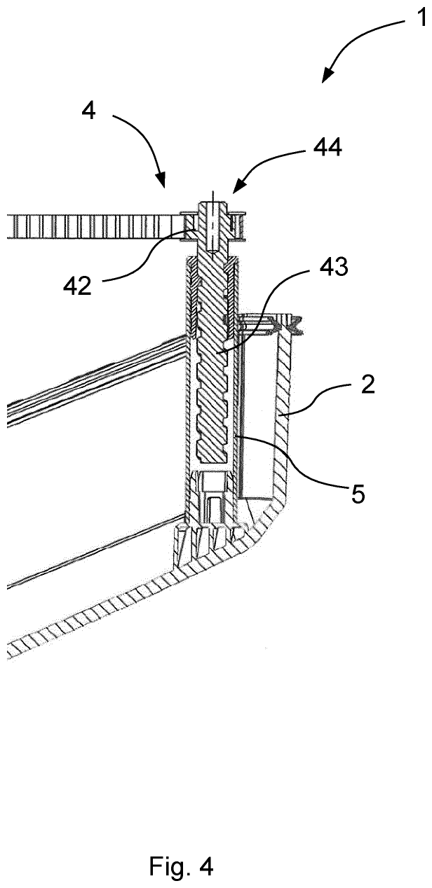

FIG. 4 shows a sectional view of the container 1 illustrated in FIG. 3 for a single-track motor vehicle. Illustrated herein are a spindle 43, a timing belt gear 42 and integrated therein a spindle nut 44 of the spindle system 4, which is arranged on the inside 21 of the first container element 2. Furthermore, the spindle system 4 is covered by means of a cover 5.

The invention in terms of embodiment thereof is not limited to the preferred exemplary embodiments set forth above. Rather, a number of variants which utilize the solution illustrated even in embodiments of a fundamentally different type are conceivable.

1-10. (canceled)

11. A container for a single-track motor vehicle, comprising:
a first container element; and
a second container element;
wherein the first container element is fastenable to the single-track motor vehicle, and the second container element has an opening for an item of luggage;
wherein the first container element and the second container element are arranged to overlap one another such that the second container element is displaceable between a first retracted position and a second deployed position on the first container element, and a volume of the container is variable;
a spindle system arranged on an inside of the first container element and on an inside of the second container element;
wherein the second container element is able to be continuously displaced and fixed between the first retracted position and the second deployed position via the spindle system.

12. The container according to claim 11, wherein
the spindle system has at least one continuous timing belt, at least one spindle, at least one spindle nut, at least one timing belt gear, and an activation element for the timing belt.

13. The container according to claim 12, wherein
an end of the at least one spindle is fixed to the second container element, and the other end of the spindle is self-supporting;
the at least one spindle is mounted in the at least one spindle nut;
the at least one spindle nut is rotatably mounted on the first container element and connected to the at least one timing belt gear.

14. The container according to claim 12, wherein
the at least one spindle nut is fixed to the second container element;
the at least one spindle is mounted in the at least one spindle nut;
one end of the at least one spindle is connected to the at least one timing belt gear,
the other end of the spindle is self-supporting; and
the spindle is rotatably mounted on the first container element.

15. The container according to claim 11, wherein
the spindle system comprises a multiplicity of spindles having, in each case, one spindle nut and one timing belt gear.

16. The container according to claim 12, wherein
the continuous timing belt extends so as to encircle the inside of the first container element.

17. The container according to claim 12, wherein
the spindle system comprises at least three continuous timing belts which are arranged in a substantially U-shaped manner, and
at a respective transition from one timing belt to another timing belt, the corresponding timing belts extend in each case about one timing belt gear.

18. The container according to claim 12, wherein
the activation element is one of:
a rotating knob having a timing belt gear,
a timing belt gear driven by a motor, or
a lever for displacing the at least one continuous timing belt.

19. The container according to claim 18, wherein
the activation element comprises a telescopic bar which connects the rotating knob and the timing belt gear, wherein
the telescopic bar is mounted in the timing belt gear so as to be displaceable along a rotation axis of the timing belt gear.

20. The container according to claim 11, further comprising:
a cover that covers the spindle system.
